(19) United States
(12) Patent Application Publication
(10) Pub. No.: US 2024/0059530 A1
(43) Pub. Date: Feb. 22, 2024

(54) Arrangement of a lock and an anchor for forming a lifting connection and a lock and an anchor therefor

(71) Applicants: J.D. Theile GmbH & Co. KG, Schwerte (DE); ABI Anlagentechnik-Baumaschinen-Industriebedarf Maschinenfabrik und Vertriebsgesellschaft mbH, Niedernberg (DE)

(72) Inventors: Martin Foitzik, Schwerte (DE); Isabella Neubert, Niedernberg (DE); Manuel Meinel, Niedernberg (DE); Christian Heichel, Niedernberg (DE)

(21) Appl. No.: 18/360,314

(22) Filed: Jul. 27, 2023

(30) Foreign Application Priority Data
Aug. 22, 2022 (EP) 22191383.3

(51) Int. Cl. B66C 1/42

(52) U.S. Cl. CPC B66C 1/42

(57) ABSTRACT

An arrangement with a lock and an anchor for forming a lifting connection for lifting a load. The anchor has a pin connectable to the load, and an anchor head that adjoins the pin and projects beyond the pin transversely to its longitudinal extension. The lock has an elongated hole with an insertion section and a holding section adjoining the insertion section and differing in its clear width from the insertion section. The elongated hole has a cross section in its insertion section such that the anchor head, in an insertion position, can be guided through this cross section, and the anchor inserted into the insertion section is rotatable around the longitudinal axis of the pin. The anchor head cannot be guided out of the insertion section in a locking position which is rotated by a certain angular amount around the longitudinal axis of the pin relative to the insertion position. The anchor is only displaceable in its locking position in the holding section and, when inserted therein, cannot be rotated around the longitudinal axis of the pin by the angular amount back into the insertion position.

### RELATED APPLICATION

This application claims priority to European application EP 22191383.3 filed Aug. 22, 2022, which is incorporated-by-reference herein for all purposes.

### BACKGROUND

Lifting connections are used to connect objects to be lifted to a lifting device, such as a crane or boom, for the purpose of lifting and/or securing. The disclosure relates to an arrangement having a lock and an anchor for forming a lifting connection for a load connected to the anchor. The load connected to the anchor includes the lifting means, and if connected thereto, also the object to be lifted. To connect the lifting means to the object to be lifted, the lifting means has an opening, an eyelet, or an attachment point.

Detachable anchor-lock connections are known for connecting the lifting means to the lifting device, for example from the German design DE 402017100332-0005 (individual parts DE 402017100332-0003 and -0004). For this purpose, a lock, which has an elongated hole, is connected to the lifting device. The elongated hole has areas of different clearance widths along its longitudinal extension: the elongated hole has a larger clear width in an insertion section than in a holding section adjoining thereon. The insertion section is usually in one plane with the holding section. An anchor is provided complementary to such a lock. The anchor is formed by a pin and an anchor head adjoining the pin. The lifting load is connected to the pin. The anchor head protrudes beyond the pin in at least one direction transverse to the longitudinal extension of the pin; it has a greater thickness than the pin, for example.

In the insertion section, the elongated hole of the lock has a cross section that is large enough so that the anchor head can be guided through the cross section. The cross section of the anchor head is smaller than the cross section of the insertion section for the ability to be guided therethrough; the cross section of the anchor head fits into the cross section of the insertion section. In contrast, the elongated hole has a smaller clearance width in the holding section, such that it is not possible to insert the anchor head here.

In order to bring the anchor into its usage position, after the anchor head has been inserted into the insertion section of the elongated hole, the anchor is displaced into the holding section where the anchor head is supported against the material of the lock surrounding the elongated hole. The pin protrudes through the elongated hole, so that the part of the pin subjected to the lifting load is arranged on the other side of the opening from the anchor head. To release the lifting connection, the anchor is displaced back into the insertion section and removed from the lock.

Such locks are usually designed in such a way that the insertion section is arranged above the holding section, so that the anchor naturally falls into its usage position as a result of its weight and is thus secured in the holding section. If a constant tensile load is applied, it usually also points downwards, so that the lock is prevented from releasing under such constant tensile load.

One problem with such anchor-lock lifting connections is an application where no constant tensile load acts on the pin, via which constant tensile load the anchor is held in the holding section. Such an application may occur, for example, when the lifting connection is used to secure the object to be lifted and the object is primarily lifted via another lifting mechanism instead of the lifting connection; the lifting connection is then secondarily employed and only engages if the first lifting connection fails. It is particularly problematic during such use as a secondary connection if a vibration or a banging movement is transmitted from the object to be lifted to the anchor. Such an application may occur, for example, on construction sites, for example when ramming. Sheet piles to be rammed into the ground are first lifted by a leader, then gripped with a ramming tool and driven into the ground. Raising a sheet pile from a recumbent position is usually accomplished by connecting the sheet pile via a chain to an attachment point near the ramming tool on the leader. Only when the sheet pile is raised to a vertical position does the ramming tool grip the sheet pile and drive it into the ground. During driving, the connection between the sheet pile and the attachment point on the leader is to be maintained in order to secure the sheet pile if the sheet pile should inadvertently release from the ramming tool.

The foregoing examples of the related art and limitations therewith are intended to be illustrative and not exclusive. Other limitations will become apparent to those skilled in the art upon a reading of the specification and a study of the drawings.

### SUMMARY

The following embodiments and aspects thereof are described and depicted in conjunction with systems, tools and methods which are meant to be illustrative, not limiting in scope. In various embodiments, one or more problems have been reduced or eliminated, while other embodiments are directed to other improvements.

Proceeding from this background, one aspect of the disclosure is to propose an improved lifting connection which also ensures greater security in the last-mentioned application above. This is provided by an arrangement of a lock and an anchor of the type mentioned at the outset, comprising: the anchor which has a pin connectable to a load and an anchor head that adjoins the pin and projects beyond the pin transversely to a longitudinal extension of the pin; and the lock which has an elongated hole with an insertion section and a holding section adjoining the insertion section and differing in clearance width from the insertion section; wherein the elongated hole has a cross section in the insertion section such that, in an insertion position, the anchor head is guidable through the cross section of the insertion section and the anchor inserted into the insertion section is rotatable around a longitudinal axis of the pin by an angular amount from the insertion position into a locking position, and in the locking position, the cross section of the insertion section prevents the anchor head from being guided out of the insertion section, since the anchor head engages behind the elongated hole at least in some sections; wherein, to form the lifting connection, the anchor head is guided through the insertion section and the anchor is displaceable into the holding section, in which the anchor head engages behind the elongated hole and the pin protrudes through the elongated hole; and wherein the lock provides a stop to the anchor, such that the anchor is displaceable in the holding section when in the locking position and, when the anchor is inserted in the holding section, the lock prevents the anchor from being rotated around the longitudinal axis of the pin by the angular amount into the insertion position. A further aspect is to specify a corresponding anchor and a corresponding lock for such an arrangement.

The cross section of the anchor head and the cross section of the insertion section of the elongated hole corresponding thereto are designed in such a way that even if the anchor is rotated in the insertion area by a certain angular amount (e.g., approximately 90°), the anchor is placed in a locking position in which the anchor head engages behind the elongated hole and is supported on the material of the lock surrounding the elongated hole, and thus it is additionally ensured that the anchor is and remains in the locking position during normal use. To remove the anchor from the lock, the anchor not only has to be displaced back from the holding section into the insertion section, but additionally rotated by the angular amount around the longitudinal axis of the pin so that the cross section of the anchor head corresponds in shape to the cross section of the elongated hole in the insertion section. If the anchor head, the pin, and the elongated hole are appropriately tolerated, it is very unlikely that the lifting connection will be released purely on the basis of banging or vibrating movements unless the lifting connection is deliberately released, so that the security of the lifting connection is increased.

To provide the locking position, the cross section of the elongated hole in the insertion section is larger than the cross section of the anchor head pointing to the insertion section in the insertion position, and smaller than the cross section of the anchor head pointing to the insertion section in a locking position rotated around the longitudinal axis of the pin in relation to the insertion position. In order to provide both positions, the thickness of the anchor head usually differs from its width in the corresponding cross section.

In the insertion position, the pin typically points in the direction in which the anchor is inserted into the insertion section. This is usually in the normal direction of the area formed by the opening in the insertion section. The walls of the opening formed by the elongated hole are typically aligned parallel thereto. For easy insertion, it is preferably provided that the cross section of the anchor head facing towards the insertion section in the insertion position is rotationally symmetrical. Depending on the order of symmetry of the cross section (an order of symmetry of two is preferred), there are multiple positions of the anchor which represent an insertion position.

In the holding section, the elongated hole provides a stop so that the anchor, or the anchor head, in this area is not rotatable around the longitudinal axis of the pin by the angular amount to be moved from the locking position to the insertion position. A straight path along which the anchor can be displaced is usually provided by the holding section. The contour of the elongated hole usually acts as a stop against the non-circular pin, which is aligned in the locked position and the thickness of which is less than its width. Appropriate stops that correspond to the anchor head are also possible.

The shape tolerance between the anchor head cross section in the insertion position and the cross section of the insertion section is proportional to the tolerated angular amount by which the anchor has to be rotated in order to be moved from the locked position to the insertion position. In particular, rotating the anchor around the longitudinal axis of the pin was considered to be particularly effective in securing the lifting connection: with a cross-sectional geometry of the anchor head and, corresponding thereto, of the cross section of the insertion section having at least one straight section that is as long as possible, for example formed along at least ½, preferably ⅔, of the anchor head diameter, a small rotation of the anchor around the longitudinal axis of its pin already causes locking, so that the cross-sectional shape tolerance does not have to be too small in order to still meet the safety requirements. In addition, in such an embodiment, the position in which the anchor is to be inserted into the insertion section of the elongated hole is indicated to an operator.

Roundings on the anchor head and/or on the insertion section in the direction of insertion and removal can simplify insertion and removal of the anchor into or out of the insertion section.

It is preferably provided that the pin includes an eye in the thickness direction for load introduction into the anchor. A chain link of a chain that is resistant to wear when it comes into dynamic contact with an item to be lifted can engage in the eye as an example of a lifting means. The chain link may be permanently connected to the anchor.

For a particularly simple attachment of object to be lifted, it can be provided that the anchor and any lifting means fastened thereon are intended to be guided through the lifting opening of the object to be lifted. Such an opening usually has an approximately circular cross section having a predetermined minimum diameter. The anchor and the chain then have to be smaller in their external diameters than this minimum diameter.

Against this background, it is preferably provided that the anchor head and the pin each have their largest diameter in the width direction. The anchor head is then narrower in the thickness than in the width direction, but protrudes beyond the anchor pin in this direction, such that support surfaces are provided for supporting the anchor in the holding section. Such a compact embodiment assists the force transmission into the anchor from the load introduction into the pin to the anchor head, since the pin provides space in the width direction for any eye or other means for attaching the lifting means for the object to be lifted and, at the same time, the force is conducted, starting from the force introduction towards the anchor head, in a straight line into the anchor head. Any roundings, undercuts, or notches are avoided, which threaten to break under a sudden load. Due to the fact that the thickness of the anchor head is smaller than its width, all of the available space of the opening of the object to be lifted can be used for the design of the pin.

In this embodiment of the anchor head, the cross section of the insertion section of the elongated hole can preferably meet at least the following conditions to enable the insertion of the anchor head: the anchor head thickness is smaller than the height of the cross section of the insertion section, the anchor head width is smaller than the width of the cross section of the insertion section, and the largest cross-sectional diameter of that area of the pin which penetrates the elongated hole in the insertion section while the anchor is rotated from its insertion position into its locking position is smaller than the smallest diameter of the cross section of the insertion section. In order for the anchor to be already blocked in the lock in the insertion section after the anchor has been rotated around the longitudinal axis of the pin, the height of the cross section of the insertion section has to be less than the width of the anchor head.

If it is provided that the anchor, when arranged in the insertion section, can be pivoted in the locking position in the longitudinal extension direction of the elongated hole, the height of the cross section of the insertion section has to be less than the anchor head height that is formed by the cross section of the anchor head pointing in the direction of the insertion section, when the anchor head is placed in the possible pivoting position in the insertion section.

The lock is preferably formed as a plate. The required contour for the elongated hole can be introduced into a plate particularly easily, for example by a milling process. The walls of the elongated hole are then the end faces of the plate. Large forces and impacts can be absorbed via a plate, wherein yielding in the event of a load usually does not result in failure, since the resistance moments in a plate are advantageously kept low for this purpose.

It can be provided that the material surrounding the elongated hole is curved at least in sections along the longitudinal extension of the elongated hole, preferably in the holding area by preferably approximately 90°, around an axis of curvature running transversely to its longitudinal extension. In this way, different load directions can be addressed; the anchor is then essentially always supported using a contact surface by the elongated hole.

For optimal contact of the anchor head on the elongated hole even in the curvature, it can be provided that the support surface with which the anchor head is supported on the lock is rounded in a radius following the curvature, which preferably has the same radius as the curvature in the support area of the elongated hole. This ensures optimal force transmission between the anchor head and the material surrounding the elongated hole, even in the curvature, and at the same time the anchor and lock are prevented from getting caught when the anchor is displaced in the holding section.

It is furthermore preferably provided that the curvature is provided at the lowest point of the lock in normal operation. If the plate is curved by approximately 90°, the plate can be tilted around the curvature axis by approximately 10° in relation to an exactly vertical or horizontal orientation. Then the anchor is usually supported in this area when it is subjected to a lifting load and lifts it up. The curvature provides a certain degree of flexibility and the largest possible contact surface between anchor and lock for the usual load case.

The insertion section is typically arranged above the holding section, for example in the area of the lock which is oriented essentially vertically in normal operation. In this way, gravitation is used to increase safety, in that the anchor normally does not come to rest in the insertion section but in the holding section due to its own weight. If the anchor should get into the insertion section—for example due to an impact or vibration—this usually only happens for a very short period of time, during which it is unlikely that the anchor will automatically (unintentionally) twist and be pulled out by the load.

It is furthermore preferably provided that the material of the lock surrounding the elongated hole is tapered in the area of the holding area pointing towards the elongated hole, forming a chamfer, and the side of the anchor head supporting itself on the lock has a bevel corresponding to the chamfer, so that under tensile load of the anchor, the anchor head aligns itself automatically. If this bevel follows the longitudinal direction of the elongated hole in the holding area, self-alignment of the anchor in the locking position is also possible under load in this way. Such a chamfer is usually several millimeters wide.

In a preferred embodiment, the anchor is a forged part. Such embodiment of the anchor as a forged part results in an alignment of the fibers in the material, which promotes a steady flow of force and is therefore particularly stable. In addition, forged parts are inexpensive to produce.

In addition to aspects and embodiments described above, further aspects and embodiments will become apparent by reference to the appended drawings, wherein like reference numerals generally designate corresponding structures in the several views.

### BRIEF DESCRIPTION OF THE DRAWINGS

The disclosure is explained below with reference to the drawings, wherein:

FIG. 1 shows a perspective view of an example arrangement having a lock and an anchor for forming a lifting connection, wherein the lock is attached to a lifting device,

FIG. 2 shows a side view of the lifting connection shown in FIG. 1,

FIG. 3 shows a rear perspective view of the lock,

FIG. 4 shows a sectional rear view of the lock,

FIG. 5 shows a top view of the anchor,

FIG. 6 shows a sectional view of the anchor taken along line A-A in FIG. 5,

FIG. 7 shows a front view of the anchor in the insertion position with the cross section of the insertion section superimposed,

FIG. 8 shows a front view of the anchor in the locking position with the cross section of the insertion section superimposed,

FIG. 9 shows a sectional view according to FIG. 6 with the cross section of the insertion section superimposed, the anchor in the locking position, and

FIG. 10 shows a sequence of six steps during the insertion of the anchor into the lock.

Before explaining example embodiments, it is to be understood that the invention is not limited in application to the details of particular arrangements shown in the drawings, since the invention is capable of other embodiments. Embodiments and FIGS. disclosed herein are to be considered illustrative rather than limiting.

### DETAILED DESCRIPTION

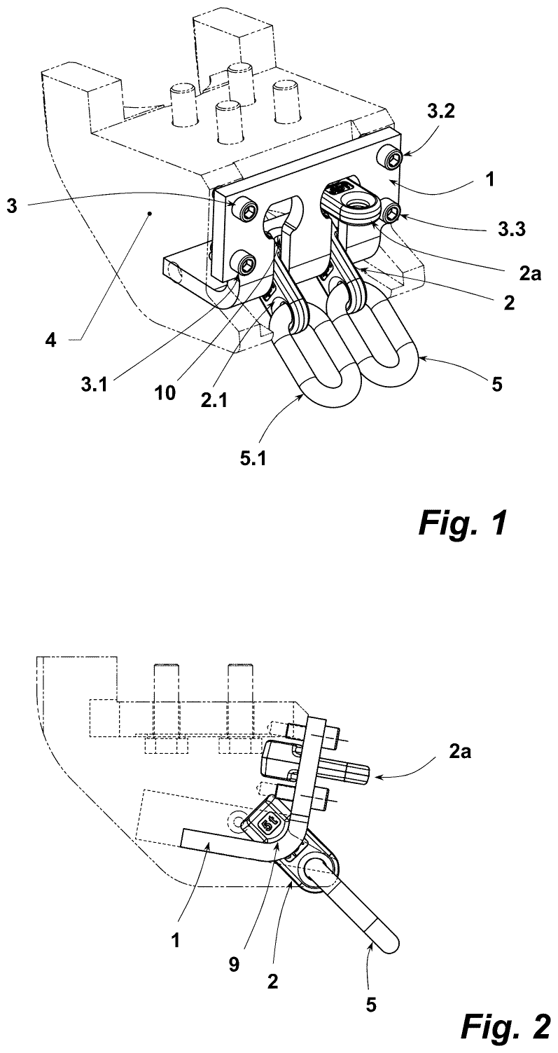

FIG. 1 shows an arrangement of a lock 1 and two forged anchors 2, 2.1, each for forming a lifting connection (the second anchor 2.1 is identical to the first anchor 2; the following statements relate to the anchor 2, but apply similarly to the second anchor 2.1). FIG. 2 is the associated side view. The anchor 2a superimposed in the upper area represents the orientation of the anchor 2 in the insertion position. The lock 1 is connected to a lifting device 4 via screw fasteners 3, 3.1, 3.2, 3.3. The lock 1 is manufactured from a plate curved by 90°. An chain link 5 is connected to the anchor 2 representing a chain as lifting means. An object to be lifted can be connected to the chain, for example, by connecting a hook to the other end of the chain, or by the two anchors 2, 2.1 with their respective chain links 5, 5.1 and additional chain links forming a common chain which is guided through an opening in the object to be lifted.

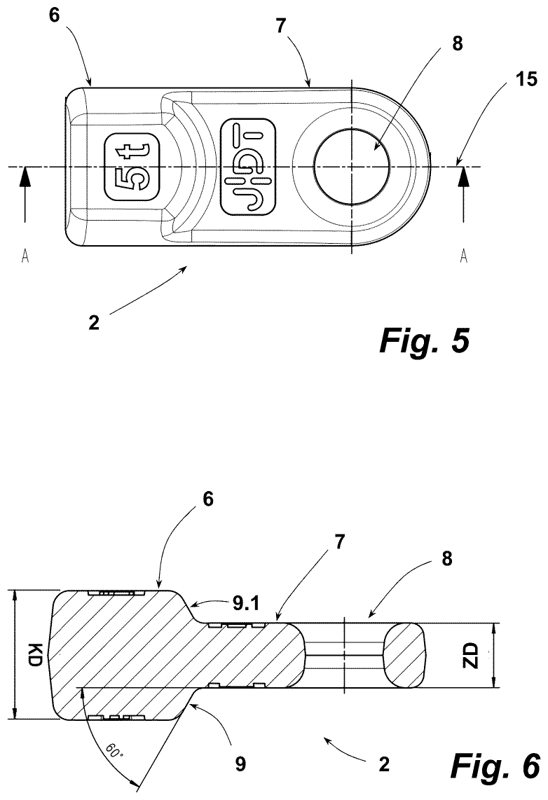

The anchor 2 has an anchor head 6 and a pin 7 adjoining thereon (see FIGS. 5 to 7). In the longitudinal extension of the anchor 2, an eye 8 is provided at the distal end of the pin 7, through which the chain link 5 engages.

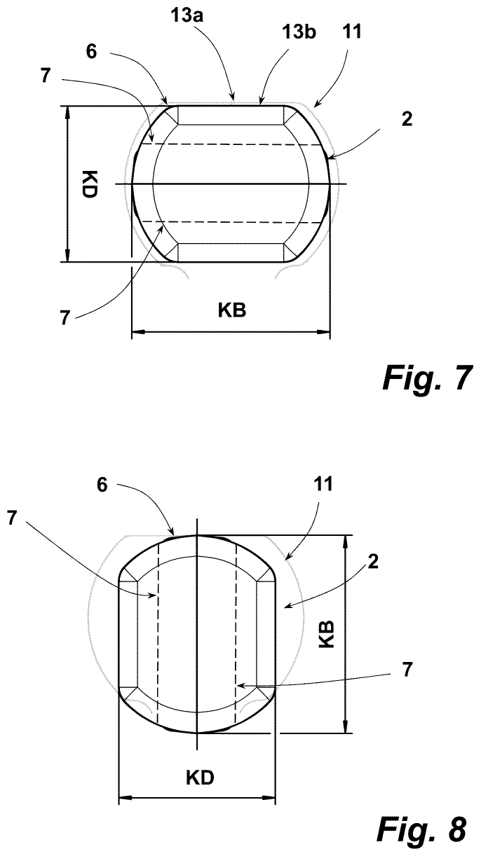

It can be seen in particular in FIG. 6 that the anchor head 6 has a greater thickness KD than the pin 7 (thickness of the pin 7 identified with ZD) and therefore protrudes beyond the pin 7. The surfaces resulting from the difference in thickness facing in the longitudinal direction of the anchor 2 are used as support surfaces 9, 9.1, with which the anchor 2 is supported on the lock 1 in a form-fitting manner. Furthermore, the cross section of the anchor head 6 is rotationally symmetrical with an order of symmetry of two (see also FIG. 7).

The largest diameter of the anchor 2 is its width KB, which is provided both in the anchor head 6 and in the pin 7 adjoining thereon. In this way, there is the possibility of aligning the eye 8 in the thickness direction ZD of the pin 2, so that force can be introduced into the anchor head 6 in a straight line, starting from the eye 8.

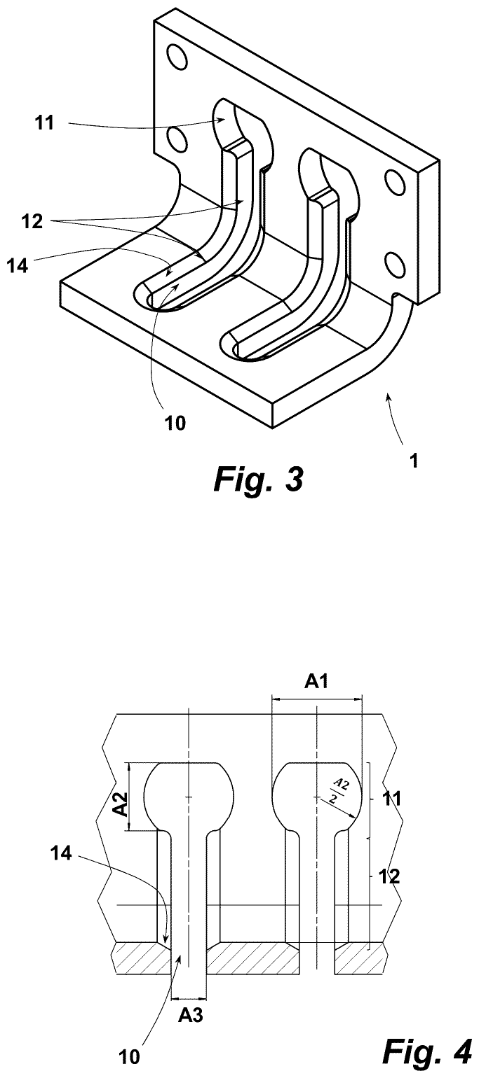

The rear side of the lock 1 is shown in FIG. 3 in a three-dimensional view and in FIG. 4 in a sectional view. An elongated hole 10 is milled into the plate forming the lock 1. In its essentially vertical section, the elongated hole 10 includes an insertion section 11 and a holding section 12 adjoining thereon below the insertion section 11 in the same plane. The width A1 of the insertion section 11 is greater than the width A3 of the holding section 12.

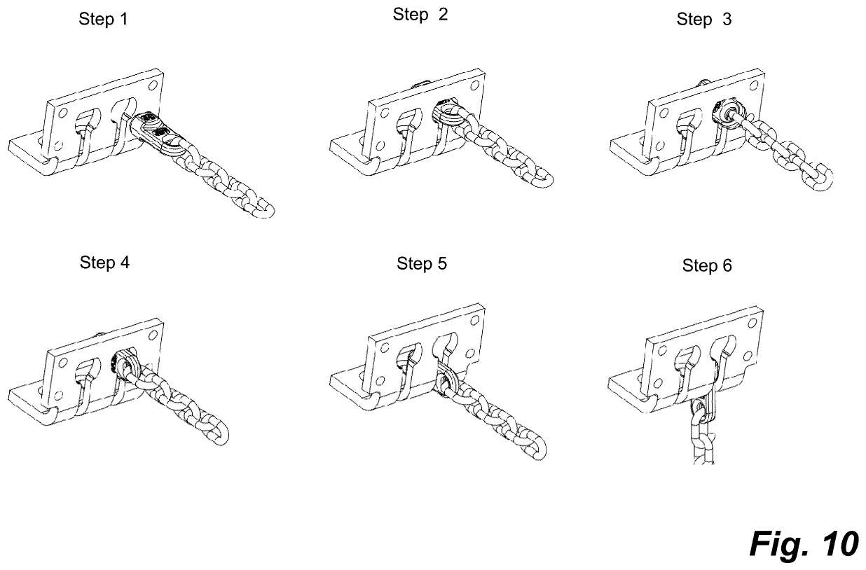

The insertion and removal of the anchor 2 in the lock 1 is shown in FIG. 10 in six steps. In step 1, the anchor 2 is positioned in relation to the lock 1 in an insertion position, where the cross section of the anchor head 6 pointing towards the insertion section 11 corresponds to the insertion cross section of the insertion section 11.

This state is shown in a front view in FIG. 7. The cross section of the insertion section 11 is shown in greyscale. It can be seen that the cross section of the anchor head 6 corresponds to that of the insertion section 11 such that the anchor head 6 is insertable into the insertion section 11. It can also be seen that the cross section of the insertion section 11 as well as the anchor head 6 has a straight contour 13a, 13b, respectively, in the upper area.

In step 2 of FIG. 10, the anchor 2 is inserted into the insertion section 11. In step 3, the anchor 2 is being rotated around the longitudinal axis 15 of the pin 7 (longitudinal axis 15 shown in FIG. 5) by an angular amount, here 90°, with the anchor 2 completely rotated in step 4. In this position, the anchor 2 is already in its locking position since the cross section of the anchor head 6 is larger than the insertion cross section of the insertion section 11 in at least one respect.

This state is shown in a front view in FIG. 8. The cross section of the insertion section 11 of the elongated hole 10 is superimposed in greyscale. The anchor 2 is rotated by 90° in comparison to FIG. 7 around the longitudinal axis 15 of the pin 7. In the lower area, the cross section of the anchor head 6 overlaps with the cross section of the insertion area 11. Therefore, it is no longer possible to remove the anchor head 6 from the lock 1 in this position. In this locking position, the anchor head 6 is supported on the material surrounding the elongated hole 10.

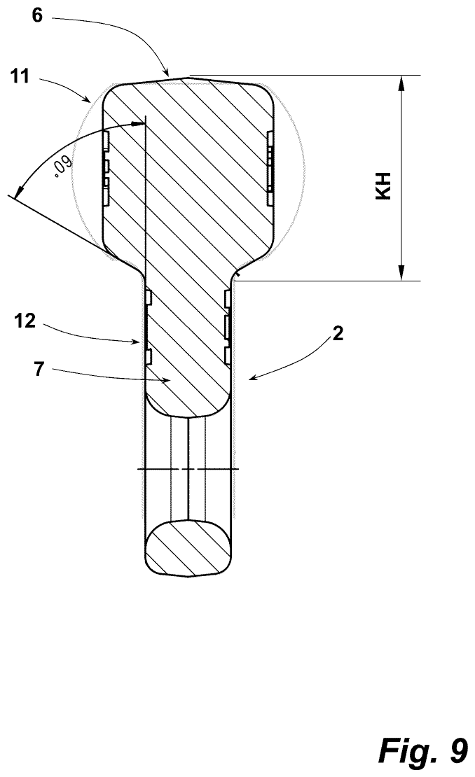

The anchor head 6 is held in the lock 1 even if the anchor 2 is pivoted, for example by 90°, in relation to the position shown in FIG. 8 in the longitudinal extension direction of the elongated hole 10 or the holding area 12, respectively. This position is shown in FIG. 9 where the head height KH of the anchor head 6 is greater than the height A2 of the insertion section 11.

In steps 5 and 6 of FIG. 10, the anchor 2 is displaced into the holding section 12. The width A3 of the elongated hole 10 in the holding section 12 is dimensioned such that the anchor 2 is held in its locking position in this area; a rotation of the anchor 2 around the longitudinal axis 15 of the pin 7—as in the insertion section 11—is not possible. The contour of the elongated hole 10 is used here as a stop means in relation to the pin 7, which has a greater width KB than thickness ZD.

In the holding section 12, the anchor head 6 is supported in a form-fitting manner in the tensile loading direction on the lock 1 with its support surfaces 9, 9.1 on the material of the lock 1 surrounding the elongated hole 10, as can be seen in FIGS. 1 and 2.

The elongated hole 10 is curved in its holding section 12 following the course of the plate of the lock 1. In accordance with this curvature, the support surfaces 9, 9.1 also have a radius in the width direction KB of the anchor 2 (see FIGS. 2 and 5). The lock 1 is connected to the lifting device 4 in such a way that the lowest point of the lock 1 is the curvature (see FIGS. 1 and 2). The anchor 2 usually pulls itself automatically into this curvature while lifting objects, where it has a maximum of contact surface due to its rounded support surfaces 9, 9.1.

For self-centering of the anchor 2 in the elongated hole 10, it is provided that the material surrounding the elongated hole 10 is tapered in the holding section 12 by a chamfer 14 (see FIGS. 3 and 4). The support surfaces 9, 9.1 of the anchor 2 are beveled accordingly for linear contact between the lock 1 and the anchor 2 (see FIG. 6).

The invention has been described on the basis of example embodiments. Without departing from the scope of the claims, those skilled in the art will recognize numerous further embodiments, modifications, permutations, additions, combinations and sub-combinations for implementing the inventive concept, without these having to be explained or shown in greater detail in the context of this disclosure. The claims should therefore be interpreted to include all such embodiments, modifications, permutations, additions and sub-combinations, which are within their true spirit and scope. Each embodiment described herein has numerous equivalents.

The terms and expressions which have been employed are used as terms of description and not of limitation, and there is no intention in the use of such terms and expressions of excluding any equivalents of the features shown or described, or portions thereof, but it is recognized that various modifications are possible within the scope of the invention. Thus, it should be understood that although the invention has been specifically disclosed by preferred embodiments and optional features, modification and variation of the concepts herein may be resorted to by those skilled in the art, and that such modifications and variations are considered to be within the scope of this invention as defined by the claims. Whenever a range is given in the specification, all intermediate ranges and subranges, as well as all individual values included in the ranges given are hereby incorporated into this disclosure. When a Markush group or other grouping is used herein, all individual members of the group and all combinations and sub-combinations possible of the group are hereby individually included in this disclosure. In general, the terms and phrases used herein have their art-recognized meaning, which can be found by reference to standard texts, references and contexts known to those skilled in the art. Any above definitions are provided to clarify their specific use in the context of the invention.

### LIST OF REFERENCE SIGNS

1 lock
2, 2.1, 2a anchor
3, 3.1, 3.2, 3.3 screw fastener
4 lifting device
5, 5.1 chain link
6 anchor head
7 pin
8 eye
9, 9.1 support surface of the anchor head
10 elongated hole
11 insertion section
12 holding section
13a, 13b straight contour
14 chamfer
15 longitudinal axis
KD thickness of anchor head
KB width of anchor head
CH height of anchor head
ZD thickness of pin
A1 width of insertion section
A2 height of insertion section
A3 width of holding section

1. An arrangement having a lock and an anchor for forming a lifting connection, comprising:
the anchor which has a pin connectable to a load and an anchor head that adjoins the pin and projects beyond the pin transversely to a longitudinal extension of the pin, and
the lock which has an elongated hole with an insertion section and a holding section adjoining the insertion section and differing in clearance width from the insertion section,
wherein the elongated hole has a cross section in the insertion section such that, in an insertion position, the anchor head is guidable through the cross section of the insertion section and the anchor inserted into the insertion section is rotatable around a longitudinal axis of the pin by an angular amount from the insertion position into a locking position, and in the locking position, the cross section of the insertion section prevents the anchor head from being guided out of the insertion section, since the anchor head engages behind the elongated hole at least in some sections,
wherein, to form the lifting connection, the anchor head is guided through the insertion section and the anchor is displaceable into the holding section, in which the anchor head engages behind the elongated hole and the pin protrudes through the elongated hole, and
wherein the lock provides a stop to the anchor, such that the anchor is displaceable in the holding section when in the locking position and, when the anchor is inserted in the holding section, the lock prevents the anchor from being rotated around the longitudinal axis of the pin by the angular amount into the insertion position.

2. The arrangement of claim 1, wherein the cross section of the insertion section has a straight contour and, in the insertion position, the cross section of the anchor head pointing toward the insertion section also has a straight contour corresponding to the straight contour of the cross section of the insertion section.

3. The arrangement of claim 1, wherein the pin, in a thickness direction thereof, has an eye for load introduction into the anchor.

4. The arrangement of claim 1, wherein the anchor head has a smaller thickness than width, and the anchor head projects beyond the pin transversely in the thickness direction, such that a thickness difference between pin and anchor head provides at least one support surface via which the anchor head is supported in the holding area on the lock.

5. The arrangement of claim 1, wherein the lock is formed as a plate.

6. The arrangement of claim 1, wherein the material of the lock surrounding the elongated hole is provided with a curvature at least in one section along a longitudinal extension of the holding section around an axis of curvature running transversely to the longitudinal extension of the holding section.

7. The arrangement of claim 6, wherein the curvature is arranged at a lowest point of the lock in normal operation.

8. The arrangement of claim 6, wherein a side of the anchor head, which faces toward the lock when the anchor is inserted into the lock, is rounded in accordance with the curvature of the holding section.

9. The arrangement of claim 1, wherein the insertion section is arranged above the holding section with respect to a gravitational direction at least when the lifting connection is formed for use.

10. The arrangement of claim 1, wherein the material of the lock surrounding the elongated hole is tapered in an area of the holding section on a side thereof behind which the anchor head engages, forming a chamfer, and a surface of the anchor head, which faces toward the lock when the anchor is inserted into the lock, includes a bevel corresponding to the tapering in the holding section such that, under tensile loading of the anchor, the anchor head automatically aligns in the locking position.

11. The arrangement of claim 1, wherein the anchor is a forged part.

12. A lock according to claim 1.

13. An anchor according to claim 1.
